(19) United States
(12) Patent Application Publication
(10) Pub. No.: US 2005/0049937 A1
(43) Pub. Date: Mar. 3, 2005

(54) Business method and processing system

(76) Inventor: Aaron Sanders, Wellesley, MA (US)

Correspondence Address: BROWN & MICHAELS, PC;400 M & T BANK BUILDING, 118 NORTH TIOGA ST, ITHACA, NY, 14850, US

(21) Appl. No.: 10/965,496

(22) Filed: Oct. 14, 2004

Related U.S. Application Data
(63) Continuation-in-part of application No. 09/640,196, filed on Aug. 16, 2000.

(51) Int. Cl. G06F 17/60

(52) U.S. Cl. 705/26

(57) ABSTRACT

A business method and a system that focuses on offering, coordinating, fulfilling and delivering an array of knowledge and productivity services that corporate customers require in today's context, the knowledge/business service combinations representing of mission-critical services with intellectual knowledge embodied, the fulfillment of which is done for a cluster of clients located in large commercial office buildings, government buildings or universities. The method of the invention provides for pooling of the requirements of various end users for scale-advantaged efficiencies in the processing and service delivery, and sharing such economies of scale generated with the building owners/property managers, who provide the venue from which to operate and enable such pooling to take place, and also with the tenant occupants/users, thus creating a market pull. The fulfillment of specific services is done by outsourcing to individual service providers who are established experts in their respective fields and who have virtual access to new business opportunities according to the method of the invention. The invention includes a market niche identification process and a networked processing system that delivers multiple-custom services to multiple-tenant users in multiple buildings/locations simultaneously, either directly and indirectly, and either with or without human intervention, and providing economies of scale and scope to all users, thus making it possible to offer such services at market-exchange pricing without the need for binding agreements. The processing system tracks utilization in a portfolio management style, by type of service as well as by user, for total spend-rates as well as by accrued savings, and for benchmarking purposes. The business method includes agents to facilitate targeted engagement of multi-tenant buildings from a location, size, networking, occupancy and potential point of view to build a network of multiple-buildings for even greater economies of scale and scope. The invention also includes applications related to wireless communications and choiceboards

### TECHNICAL FIELD

This invention pertains generally to the fields of business methods, computing, and communication. More particularly, the invention pertains to the field of information technology-based service fulfillment, tracking, and coordination, as well as methods and systems of engaging in service delivery utilizing web-based connectivity, more popularly known as e-services. In addition, it includes applications related to wireless communications and choiceboards

### BACKGROUND AND SUMMARY OF THE INVENTION

A. General Background and Summary

The method of doing business traditionally used in the commercial office building industry by building owners is to find a commercial client willing to lease office space, making the client agree to pay a certain rental rate for use of a specified space for a specified term, and the building owner building out the space according to custom requirements of the client or simply making the space available for occupancy without such build-outs. The business has traditionally been one of leasing space and thereby providing a convenient location for the commercial client in question.

Over the years, however, the requirements of tenant customers have changed, primarily due to lifestyle changes and due to behavioral changes of the commercial client employees who are the tenant occupants in commercial buildings. The needs of clients have thus shifted from one of mere location, to one of a combination of floor space with certain services. As a result, the services expected or desired from building owners has been changing dynamically. For example, building owners some years ago added cafeterias and restaurants within their buildings to make it convenient for occupants to have access to food, beverages and snacks beyond the vending machine. Some building owners also added day care centers and health clubs. The whole idea behind adding such amenities was to make life convenient for the occupants so that they did not have to leave the building premises frequently, and so that the tenant occupants had a more productive atmosphere to work in, all of which contributed to the commercial client's satisfaction and continued occupancy.

Some building owners in the recent past have begun to introduce a concierge service that engages a concierge onsite to provide services such as theater ticket reservations and limousine reservation services to all tenant occupants. All of the above services are usually added for the benefit of tenant occupants and have one thing in common in that they cost the building owner money to provide—either in the form of labor costs, as with concierge services; or in the form of subsidized rents and/or investments, as with health clubs and day care centers; or in the form of non-rental revenue generating floor space, as is required for seating outside the cafeterias. In spite of many amenities already existing, changing market conditions coupled with time pressures on tenant occupants, the demand for services inside larger commercial office buildings continues to increase. In fact, some building owners refer to the commercial office building business as one of “pure services” rather than one of “floor space”, since the flooring and the wall colors no longer offer any differentiation.

Certain other trends are taking place in the general market as far as companies or end users of services are concerned. For example, companies are beginning to outsource services in a big way. Estimates show that outsourcing is growing at over 30% annually. The main reason is that the information age has led to the emergence of so-called “smart markets” as defined by frequent turnover in the general stock of knowledge or information embodied in products or services and possessed by competitors and consumers. Customer behavior in smart markets is characterized by the twin requirements of freedom of choice and help in making choices. And, as a result, the relationship between customer and supplier, especially for business services, is gradually shifting from one of a captive supplier to one of strategic partnership. Moreover, with information more readily and freely available, competitive pressures are causing a shift in the pricing for business services from one of strategic partnership to one of market exchange. This means that customers today want custom-services for commodity-like pricing. Traditional paths used by individual business service providers to reach customers have included direct sales and sales through indirect channels such as through agents, value added resellers and retail channels. Moreover, emphasis in outsourcing has in the recent past started to shift from parts, components and sub-systems to greater unexploited potentials that intellectually-based systems offer, such as:
a) Obtaining of higher value and greater flexibility by the buyer,
b) Improving the buyer's capacity to stay current by interacting with best knowledge sources, and
c) Achieving cross-dimensional coordination, reduced capital investments, and shareholder value gains that could not be achieved otherwise.

Providers of business services typically have a focus in a single industry such as printing, marketing communication, video conferencing, consulting or office supplies. Individual business service providers do not consolidate or deliver requirements for varying business services that are typically provided by focused industry players, nor has any individual service provider thus far linked all the business services needed by companies to properly and efficiently conduct their administrative functions, either due to limitations of focus or of technology. With the recent advent of networking technology, and the bandwidth increase in web connectivity, commercial office buildings that are already wired or are being wired and connected within and outside the building for exchange of data, routing of information, and communication in general are now in a position to be connected to multiple individual service providers through a linking mechanism according to the business method of the invention. Large multi-tenant commercial office buildings today, due to their networked properties, can be viewed as a systematic collection of sophisticated consumers and knowledge workers all linked to each other and at the same time physically located in a vertical format, as in skyscrapers, or in a horizontal format, as in office parks—providing an ideal venue for consolidation, processing and delivery of business services. The business method of the invention relates to this very consolidation for processing and fulfillment while simultaneously sharing the benefits of the economies of scale and scope so derived with the building owners who provide the very venue.

Most large buildings with floor space exceeding 350,000 square feet are typically occupied by around 1,000 people at 80% or greater occupancy levels, and at least 80% of the occupants are considered to be knowledge workers. This means that a multi-tenant commercial office building site of over 350,000 square feet, consisting of a collection of small, medium and large companies, assembled in some format within a single physical location, and networked to the web, is virtually equivalent to a Fortune 1000/large corporate account from a business potential standpoint. This is the new market, which hitherto did not exist and could not in the absence of connective technology that the business method of the present invention is addressing.

Because of the above recent market developments, there exists a new opportunity resulting from combining the needs of building owners, the need for new business services, and the existing technology that enables appropriate connectivity with individual service providers and tenant occupants to facilitate the service delivery seamlessly. This is the market niche presenting a new business opportunity according to the business method of the invention.

Most business services and office supplies that are purchased by companies, however, are based on established commercial relationships. The mid-size and small market segments, with roughly 70 million employed in the sector, are growing rapidly, whereas the Fortune 1000 companies' segment, which employs roughly 20 million people, has shown no net employment growth in over a decade. Proximity of service provider and cost-effective total solutions that enable customers to improve their productivity are sought after by companies, and the key to fulfilling this is a scale-advantaged service offering. The total commercial office building space in the US, for example, is roughly 10billion square feet occupied by over 25 million knowledge workers. With business services being a hot new trend, and desired by knowledge workers, such buildings provide the ideal venue for a business services provider. The engagement of building owners as partners for the fulfillment of these services provides a method of continuing the relationship from the new service provider to the ultimate tenant user through the building owner, where the relationship already exists, and this is one of the key linkages according to the business method of the invention.

Using print-on-demand as an example, classes of current service providers include (a) the transaction/retail model which is essentially a mass-market business handling many jobs per day for many customers at convenient locations for walk-up traffic—such models avoiding highly complex equipment/transactions; (b) the service/quality model which is essentially a relationship business based on good quality and service for specialized jobs to a set of regular customers, such models being dependent upon specialists and strategic relationships between service providers and customers; and (c) the systems/contract model which is entirely a relationship model where the service provider deals with relatively few number of very large customers, such models requiring the customers to pay a premium for process reengineering and data-content management to achieve specific business objectives.

According to the method of business of the invention, the processes of order-entry, fulfillment, or tracking for business services will be facilitated by the networking within the building, and one ends up with an opportunity to create a new model, one that is a mix of the transactional and contract models, to deliver specific business objectives via complex equipment and complex transactions in a transactional format to users without them having to invest or pay a premium. This is achieved by pooling the requirements of many sophisticated users and outsourcing the pooled complex requirements to the world's best service providers who set up facilities onsite as one of the embodiments of the business method of the invention.

Planned investments in e-commerce systems as of mid-1998 exceed $23B over the next 3 years, and the future of electronic support will blend digital and human help. All these contribute to the evolution and market potential of the new business method.

Access to flexible capacity, intellectual capability, and fast service turnaround are key to providing a quality service business. When the acquisition of business services is not the core competency of the acquirer or buyer, they normally outsource the service to a qualified supplier for fulfillment. Some buyers specialize in procurement of particular business services and engage in the identification of individual service providers, price negotiations with such suppliers, as well as coordination of activities at the buyers' end. This has led to increased activity and increased number of transactions over time at the buyers' end, while requiring the buyers to update themselves on the technical aspects of services they need to procure but which are not their core competency. This has led to the spurt in outsourcing and the benefits sought by companies has gone beyond those associated with a product or service to the following:
a) convenience—one stop shopping and timesaving,
b) participation—cooperation, information exchange and customization, and
c) anticipation—proactive development of service offerings and innovation.

My invention provides a business method and a system that focuses on fulfilling an array of knowledge and productivity services that businesses require in today's context, the knowledge services representing a combination of mission-critical business services with intellectual knowledge embodied in such services, and the fulfillment of which is done for a cluster of clients located in large commercial office buildings, government buildings or universities. My invention provides a method for moving a “goods” and “services” business upstream, from one traditionally catering to users on a one to one basis predominantly by individual service providers, to one of a “transformation” business where, instead of merely providing tangible things or performing specified activities, one transitions to “achieving demonstrated outcomes for customers”. The invention results in the creation of a market share building vehicle for the adopter of the business method of the invention due to the efficient manner in which many buildings can be quickly assimilated into the process and the manner in which building owners are engaged, which is different from their traditional business method of “leasing space”. Due to the possibility of consolidating the volumes and revenues generated in the buildings where the new business method of the invention is applied, and especially in networked buildings, enormous scale and scope advantages become available. And, since the scale-advantage is shared with users, a customer pull is experienced as opposed to a sales push that one currently observes in the marketplace when they engage individual business service providers through the traditional methods of doing business.

Most suppliers and individual service providers, as mentioned earlier, focus on one specific product or service, and only sometimes on combinations of more than a few related ones, such as in business centers or retail outlets of service providers. But where such combinations of business services are offered, they are not interconnected either with each other, with the service provider, and the user on a long-term basis. Very rarely does one see combinations of unrelated business services being provided from a single source, and even if that were observed, the connectivity does not exist. In all cases, individual service providers focus on one company or corporate user at a time as their client. Custom services are almost always made available under specific agreements with somewhat inflexible terms and conditions, many of which bind the buyer and/or the provider to some degree due to a buyer/provider investment needed for on-going fulfillment. I use a networked system that delivers custom services, either directly or indirectly to buyers, with or without human intervention, and provides economies of scale and scope to all users, therefore making it possible to provide services at market-exchange pricing to corporate tenant occupants without any binding agreements. Moreover, the business method tracks a portfolio of services, for usage by type of service as well as by user, for total spend-rates and savings, and for benchmarking purposes, especially with corporate clients in similar industries. The business method also incorporates the building owner as part of the mechanism in the value chain to successfully bring clusters of customers together so they can be accessed simultaneously and the processing and fulfillment done in such a manner as to generate economies of scale and scope.

My business method of the present invention systematically pools the requirements of tenant building occupants and overcomes the deficiencies of the prior art by efficiently linking individual business service providers, who use traditional methods for selling or for fulfilling services, to ultimate users in multi-tenant commercial office buildings, based on the knowledge service requirements of such users. The building owner is one of the links according to the method of the invention in that the owner is a means to creating a venue for assimilating and fulfilling the service requirements of the various users who occupy the building, some of the service fulfillment being done in the venue, or onsite, and some being done offsite by connecting users via the venue to individual business service providers for direct fulfillment.

The method of business according to the invention creates a coverage advantage for promoting existing and new services based on the selection of the right building with a cluster of sufficient potential end users in one physical location either in a vertical or in a horizontal format. It thus delivers sales coverage cost efficiencies relative to traditional business development methods and offers advantages of low new business development costs for individual service providers. It also provides for riding on the marketing communication vehicles of building owners to promote the services and to make specific business service announcements, thus reducing market promotion costs relative to traditional business methods.

The business method also includes a method of utilizing select agents for finding the building owners in a given territory so that various buildings can be linked simultaneously for greater economies of scale and scope. The function of the agent engagement is to facilitate targeted engagement of the right multi-tenant buildings from a location, size, networking, occupancy and potential point of view. Agents follow a seven-step customer engagement process as is described later.

Once the building owners provide the venue, they benefit from the revenues and/or profits of the scaled and pooled service offerings provided according to the business method and as such become partners in the venture—benefiting from the space through the knowledge service promotion which has the potential to yield more than two times the rental equivalent of the floor space as might be achieved in a traditional lease of space. Also, they succeed in providing services generally desired by their tenant customers onsite, thereby increasing the value proposition of the floor space they rent out to tenants. This is where the method of the present invention generates higher returns and creates new value for building owners while simultaneously enabling them to provide the business services that are most needed in their buildings and thus providing new value to tenants also in the process.

B. Wireless Service Delivery Methodology and System Background and Summary

Procurement of business services and their delivery has traditionally been conducted in a face-to-face manner, gradually shifting towards telephone and fax and in recent years to the web. In all these cases the amount of information that needed to be submitted by the buyer was significant as can be documented by extensive order forms and or job tickets.

The current state of wireless devices is limited to information exchange via voice or text and its data use is limited to email. The current systems do not allow the exchange of large amounts of information feasible as is typically required for service requests and for procurement of business services. The small screens of wireless devices and limited information input and transmission capabilities thus limit their use to simple transactions—such as information search with simple inputs.

The system of the current invention bridges the gap between the need to submit large amounts of information to complete an order and the limitations inherent to wireless devices. This is accomplished by storing the information associated with an order in a library of orders. Such a library can be accessed with a wireless device and any of the stored orders can be retrieved, with minimal information added specifically relating to the order in question and entered with a wireless device and submitted via the wireless networks that exist.

This database of orders can be maintained through other means—in most cases through the Internet. A user can therefore log into a web site with his/her username and password to create new, as well as edit and delete previously created orders. The data and metadata associated with such an order are stored in a database that is also enabled for access by wireless devices.

This way the information intensive communication is performed through channels with higher bandwidth (enabled mainly by an easier input method), the wireless device is only used to retrieve previously stored information and add or amend certain details associated with the order.

C. Choiceboard Methodology and System Background and Summary

The method of doing business for buying or selling of products and services between occupants of multi-tenant commercial office buildings has traditionally been to find the prospective customers or suppliers of the products or services in question from a directory of the respective building and/or to call the office of the tenant company concerned where the name and type of business done by the company is known. Once connected to the receptionist or the entry point at the company, whether via a phone call, mail, e-mail or a physical face-to-face visit, the introduction to the most appropriate contact person for the business purpose intended takes place. This process of searching for procurement of products or services or for marketing and sales of products and services is both time-consuming and effort-intensive. And, the building owner in the traditional context has little to do with the process of enabling business transactions and adds no value to the tenant companies housed within the building or buildings owned by the respective building owner, even though these businesses reside in properties with common ownership. In other words, building owners have thus far been unable to take advantage of the common denominator that they have—viz. occupants of their floor space, and link them with each other with the application of appropriate web technology or otherwise.

The business of building owners has traditionally been one of leasing space only and thereby providing a convenient location for the commercial tenant clients. Over the years, however, the requirements of tenant companies and tenant clients have changed. With the advent of the Internet and network connectivity, tenant companies have come to expect more in the infrastructure of the space they occupy in the form of business amenities. The needs of tenant companies and their occupants have thus shifted from one of mere location, to one of a combination of floor space and business services. As a result, buildings and space are no longer differentiated by the quality of paint or flooring or even the location itself anymore. It is increasingly becoming the quality and type of services and amenities offered by building owners that are beginning to differentiate office buildings from each other. For example, building owners added cafeterias and restaurants, day care centers and health clubs within their buildings to make it convenient for the occupants to have access to food, child care and recreation facilities within close proximity of the office complex. But such amenities have become commonplace now. Today, the need is for high-speed connectivity; telecommunication bundles that save tenants money, wireless services and easy access to multiple business services. Certain trends in the marketplace are also influencing what business service amenities are coming to be expected of building owners and what specific services make sense for building owners to aggregate and offer to the tenant companies occupying their multi-tenant commercial office buildings. For example, companies are increasingly outsourcing business services and estimates show that outsourcing is growing at over 30% annually. At the same time, communications is also growing and there is an increasing need for high-speed web-enabled communication as well as wireless access.

Providers of business services typically have a focus in a single industry such as printing, marketing communication, video conferencing, consulting or office supplies. Individual business service providers do not consolidate or deliver requirements for varying business services that are typically provided by focused industry players, nor has any individual service provider thus far linked all the business services needed by companies to properly and efficiently conduct their administrative functions, either due to limitations of focus or of technology. With the recent advent of networking technology, and the bandwidth increase in web connectivity, commercial office buildings that are already wired or are being wired and connected within and outside the building for exchange of data, routing of information, and communication in general are now in a position to be connected to multiple individual service providers through a linking mechanism according to the business method of the invention. Large multi-tenant commercial office buildings today, due to their networked properties, can be viewed as a systematic collection of sophisticated consumers and knowledge workers all linked to each other and at the same time physically located in a vertical format, as in skyscrapers, or in a horizontal format, as in office parks—providing an ideal venue for consolidation, processing and delivery of business services. The business method of the invention relates to this very consolidation for processing and fulfillment of products and services offered by the occupants themselves for the other occupants while simultaneously sharing the benefits of the economies of scale and scope so derived with the building owners who provide the very venue and platform to make it happen—both in the physical dimension as well as in the electronic portal platform.

Most building owners or REITS (real estate investment trusts) own several large multi-tenant commercial office buildings with floor space exceeding 350,000 square feet are typically occupied by around 1000 people at 80% or greater occupancy levels, and employed by approximately 15 different tenant companies. This means that a building owner or REIT is a conduit to multiple multi-tenant commercial office building sites of over 350,000 square feet, consisting of a collection of small, medium and large companies, assembled in some format within clusters of a few physical locations, and networked to the web, and can be virtually equivalent to a conglomerate of corporate accounts that have immense potential to transact business with each other. This is the new market segment, which hitherto did not exist and could not in the absence of connective technology employ the business method of the present invention.

Because of the above scenario and the recent market developments, there exists a new opportunity resulting from combining the needs of tenant companies, the need for new business services by these companies, and the need for building owners to differentiate themselves, to use technology that can enable appropriate connectivity with individual product and service providers within the buildings owned by a common building owner and/or REIT to help the tenant companies occupying the space to transact business with each other more efficiently and with ease. This is the market niche that presents a new business opportunity according to the business method of the invention.

The business method of the present invention systematically pools the selling and buying requirements of tenant companies who are in the buildings of a common building owner or REIT and overcomes the deficiencies and inefficiencies of the prior art by instantly linking buyers and sellers seeking products and services at pre-negotiated or pre-determined discount structures for neighbors. The method of business according to the present invention creates an advantage for promoting existing and new services for all tenant companies and expands their market reach due to the lack of need for sales coverage to promote such offerings. Also, reaching out to a cluster of buildings owned by a single building owner or REIT enables a tenant company to have access to buy or sell products and services on preferred terms and pricing with a broader audience. The electronic reception on the other hand, can enable tenant companies to steer the flow of information and interest from potential clients speedily, effectively and efficiently to the respective person or group as the case may be for immediate response. And, the building owner or REIT thus creates a new platform for opportunity exchange, with a database that can track transactions so as to enable a slice of the action if and when desired.

Currently, there are many auctions sites that have sprung up and applications such as those of eBay which allow for multiple bids relating to a single product offering including auto-bidding for those buyers interested in bidding up the price slowly based on market movement, but such auctions serve the purpose to maximize the achieved pricing of the seller. On the other hand, there are many vertical B2B e-commerce exchanges catering to single industries that have been established over the past couple of years and the sole objective of such exchanges is to enable an efficient procurement transaction for the buyers and sellers within the exchange. Because of the very nature of the electronic sorting focus of the exchanges, these vertical exchanges in the present state of the art simply list offerings, match buyer and seller needs within the market space and attempt to bring in many supplier bids for a single request for procurement. Again, due to the structure of these exchanges, what they end up leading to a market-pricing level based on supply and demand, which essentially leads to maintaining pricing levels that are market clearing prices according to the fundamental economic theory of supply and demand. Exchanges therefore seek to increase the population of buyers and sellers and their listings, as true market pricing is achieved more efficiently when more buyers and sellers are in the exchange with more offerings enabling more transactions. In short, both the auction sites as well as the vertical exchanges of the present art, tend to commoditize offerings in their own ways, one maximizing seller power and the other maximizing buyer power up to the limit of market-clearing pricing.

The business method and processing system of the present invention essentially creates a reverse auction type of web-based system where instead of maximizing seller power and the net yield for sellers, as in the case of auctions, or maximizing buyer power only to the limit of market-clearing pricing, sellers offer preferred deals for select offerings to buyers within a community of tenants, and such buyers receive the preferred deals that are below market-pricing, thus making it more efficient for the buyers than vertical exchanges and opening up a new market at virtually no cost for sellers to engage in neighborly dealings with a new community that they could not access efficiently till today. So, this concept is about “preferred offerings” to preferred end-users, wherein a community of tenants, that has access to select product/service offerings at preferred pricing on preferred terms—typically at below-market pricing, and the mechanism is economically efficient for both buyers and sellers. The business methodology of the present invention is thus unique and the mechanism of the B2B Choiceboard that enables efficient neighborly dealings does not exist in the present art.

### DESCRIPTION OF THE DRAWINGS

The invention is pointed out with particularity in the appended claims. However, other features will become apparent and the invention will be best understood by referring to the following detailed description in conjunction with the accompanying drawings in which:

FIGS. 1 through 10 pertain to and deal with the general methodology and system of the invention.

FIG. 1 is a flowchart representing the business methodology of the invention as discussed above.

FIG. 2 is a descriptive representing the principles of the value creation through the business methodology as discussed above.

FIG. 3 is a schematic illustrating the domain of knowledge services typically outsourced by companies in the current market context as discussed above.

FIG. 4 is an example of the market sizing for select knowledge services, essentially a scoping of the business method market potential according to my invention.

FIG. 5 is diagram of a market niche identification methodology according to my invention.

FIG. 6 is a schematic illustrating the value differentiation process for knowledge services.

FIG. 7 is a customer engagement process illustrating a preferred process of building owner engagement and building the network of building owners according to my invention.

FIG. 8 is a process of data flow schematic illustrating a preferred process of connectivity of the users to the service center for a print-on-demand service fulfillment according to an embodiment of my invention.

FIGS. 9 and 10 are a descriptive illustrating the design criteria for a preferred overall system for web connectivity according to my invention.

FIG. 11 is a schematic multidimensional chart illustrating the relationships between the different data flow components according to the business method of the invention in one example of digital printing service fulfillment.

FIG. 12 is a schematic diagram illustrating a preferred process of data flow according to a method of the invention.

FIGS. 13 and 14 pertain to and deal with the methodology and system of the wireless delivery system of the invention.

FIG. 13 is a flowchart representing the technical solution of the wireless delivery system of the invention.

FIG. 14 is a schematic showing an example of how a business service (in this case digital printing) can be easily ordered online by selecting a previously created order (which includes the files to be printed, which is/are stored on the server) as well as additional metadata associated with the order (in this case number of copies and other print job options.)

FIGS. 15 and 16A through 16F pertain to and deal with the methodology and system of the Choiceboard aspect of the invention.

FIG. 15 is a flowchart representing the business methodology of the Choiceboard aspect of the invention.

FIGS. 16A through 16F provide schematic diagrams and flowcharts representing the process flowchart of the Choiceboard aspect of the invention.

### DETAILED DESCRIPTION OF THE INVENTION

A. Detailed Description of General Principles

The invention is a business method that helps to create an e-service outsourcing enterprise delivering “productivity” to customers through an array of back-office knowledge services, allowing such enterprise to be a market pioneer utilizing scaling and pooling of knowledge services via operationally efficient technology-linked service providers, and to deliver value to end-users on-line as well as on-site through implementation “kiosks” or venues. The business method ensures that everybody in the chain either makes or saves money, and provides knowledge-based business services at the doorstep of tenant customers by partnering with building owners.

The business method of the invention attempts to:
1. Establish productivity service centers (PSCs), or kiosks or venues, in large commercial office or government buildings, preferably of 350,000 sq. ft. or greater and occupied by at least 1,000 people, or in university-type settings with equivalent knowledge-worker populations, offering a complete range of “back-office knowledge and productivity services” in partnership with building owners/property managers;
2. Deliver pooled and scale-advantaged service efficiencies online through a business performance management system, as well as through skilled and knowledgeable front-line business people on-site, to the doorstep/desktop of tenant customers enhancing the value proposition of the buildings themselves;
3. Nurture the partnerships with two of the most valuable assets—operational excellence and a brand that can be built in this niche market, by delivering unparalleled productivity through cost-management and service fulfillment;
4. Increase the network of productivity site operations rapidly to a critical mass, offering significant on-going incremental value to existing and future customers once all such service centers are connected with each other.

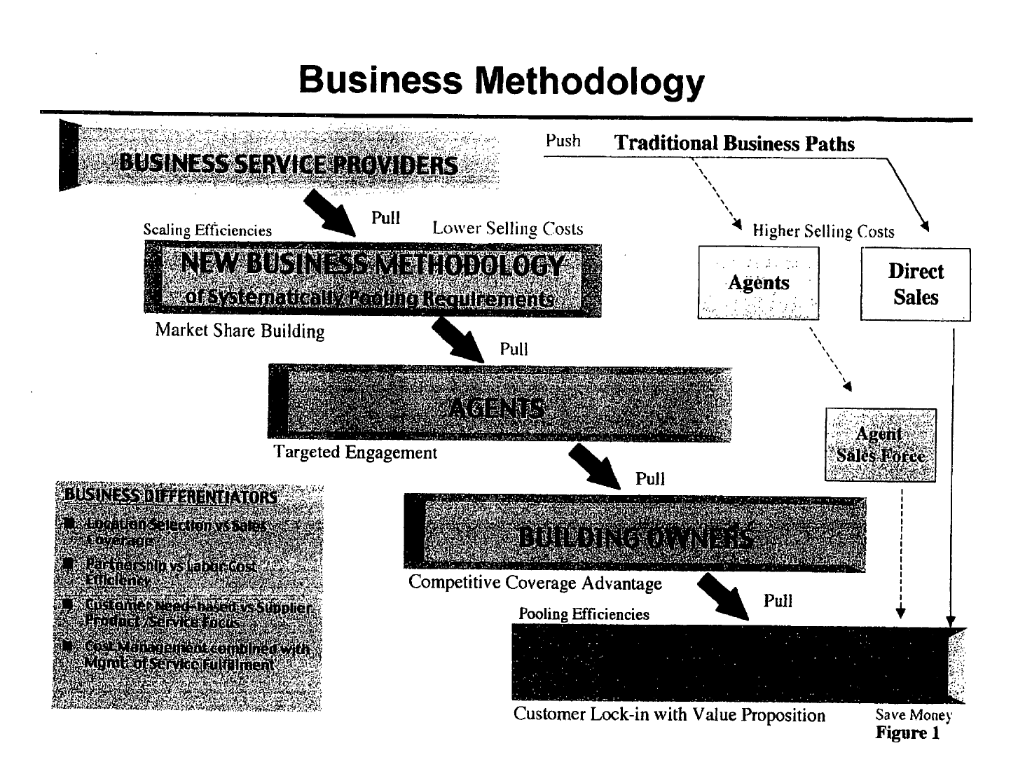

FIG. 1 is a diagram of the business methodology as it links individual service providers according to my invention to clusters of end users located in a commercial office building. The pictorial representation of the relationships between the many groups engaging with each other is useful in understanding the traditional business paths and the path according to the invention. Here, the principal difference is that a market pull is created due to the value proposition of cost-management and service fulfillment. Moreover, when combined with the coverage advantage in the building context and the targeted engagement to reach building owners, the method of the invention lowers overall selling and marketing costs for knowledge/business services while generating economies of scale and scope that could not otherwise exist. The method also provides an economical means of reaching out to new potential customers for individual service providers by offering them instantaneous connectivity to all tenant occupants, thereby increasing their market penetration in the buildings/properties by as much as two to three fold immediately.

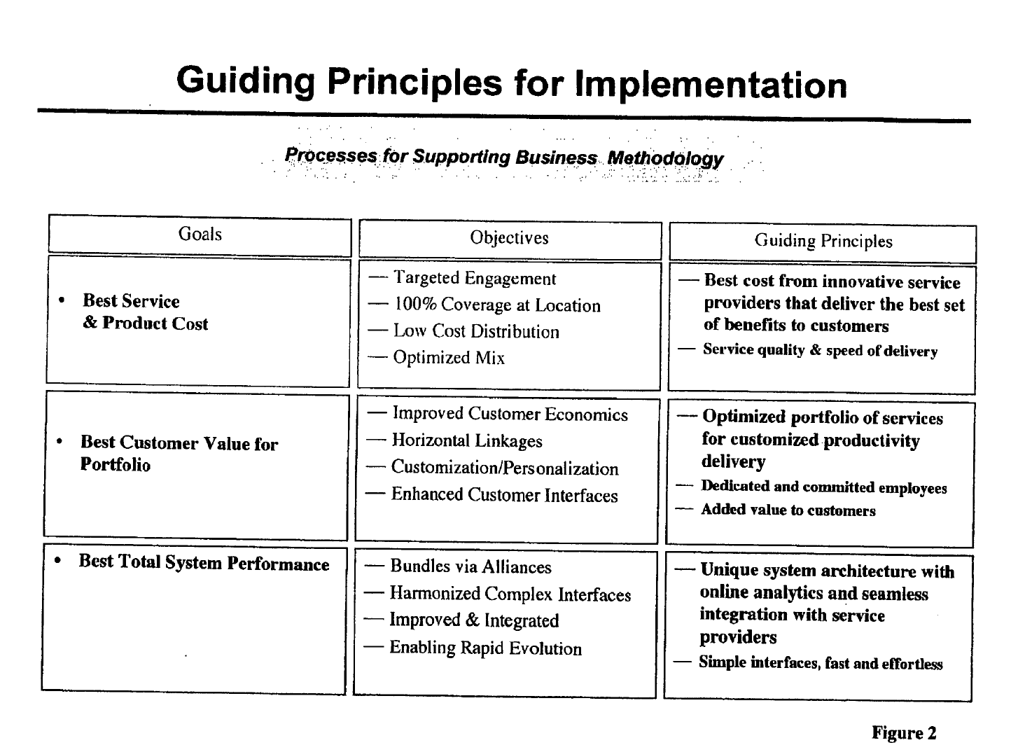

As seen in FIG. 2, which is a descriptive representation of the goals, objectives and guiding principles of the business method of the invention, the low distribution costs, combined with the optimized service mix, customization and personalization, and harmonized complex bundling of alliances with a seamless integration, is what provides value from the new business method,

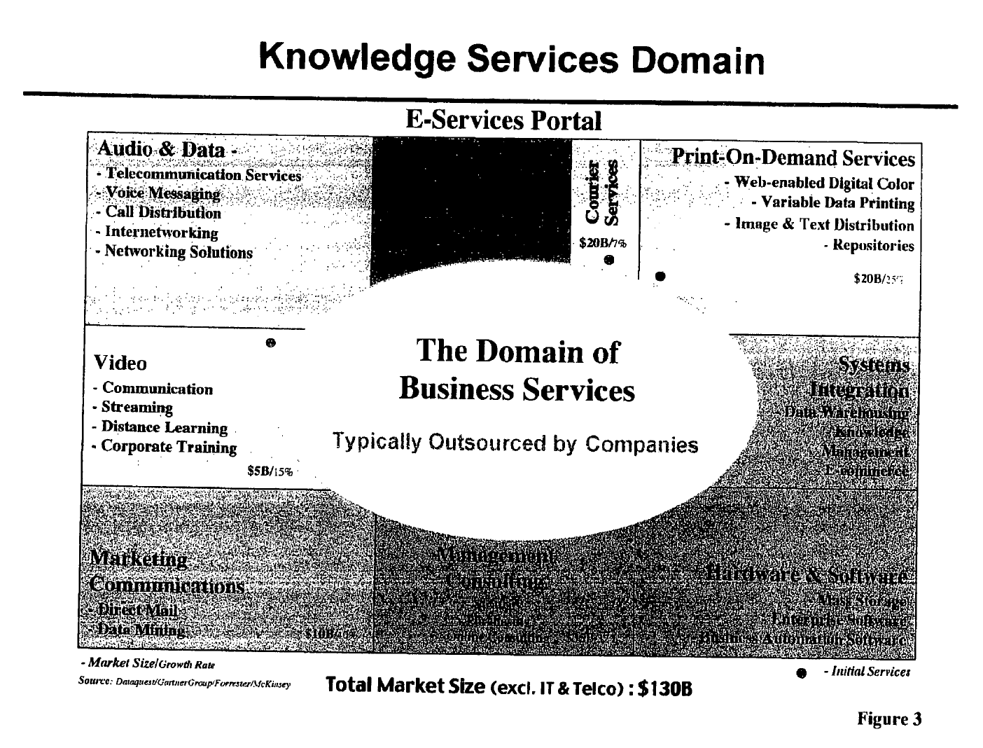

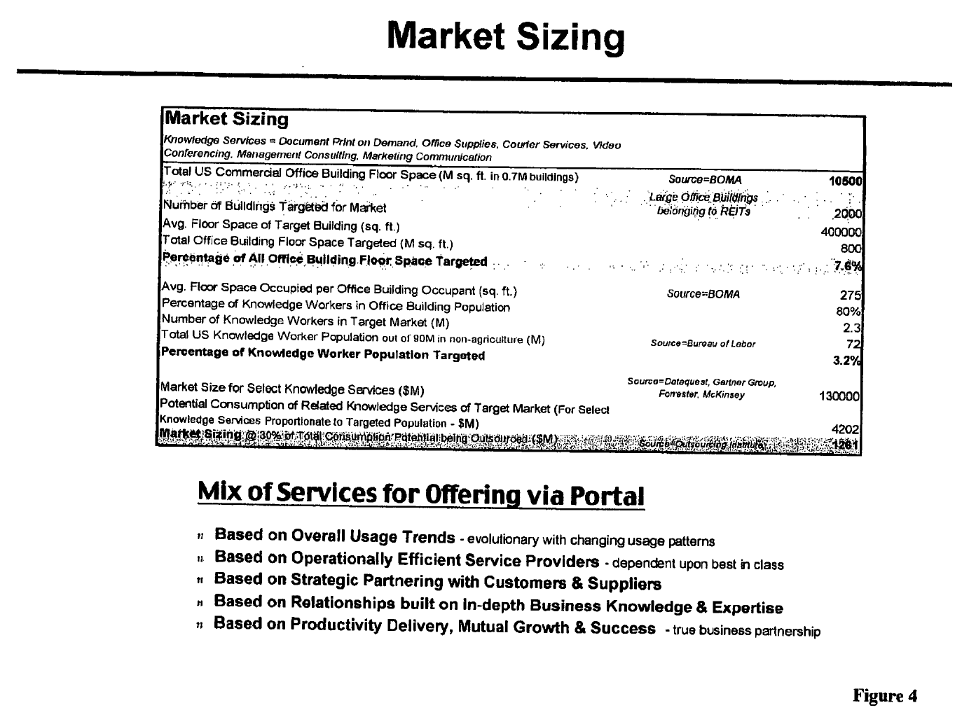

As I define the knowledge services domain, as shown in FIG. 3, it includes web-enabled print on demand and variable data printing, image and text distribution, and repositories; digital, local and domestic courier services; office products and services distribution and fulfillment; video communication, conferencing, video streaming, distance learning and corporate training; marketing communications such as direct mail, direct email, and data mining; audio and data services, such as voice messaging, call distribution, and internetworking; management consulting, including online consulting, purchasing, procurement, outsourcing, and strategy consulting; as well as systems integration such as data warehousing/mass storage; e-commerce live human interface; and business automation software/tech-support. The market size for these knowledge services in 1999 is of the order of $130B per year excluding information technology, which is roughly another $130B, and telecommunications, which is roughly an additional $300B. FIG. 4 shows the market sizing for a select few exemplary knowledge services in the preferred targeted market segment; the market size appears to be well over $1B. Thus, a mix of the services offered via a portal that is based on overall usage trends and is evolutionary in nature would be a preferred method of implementation according to the business method of the invention.

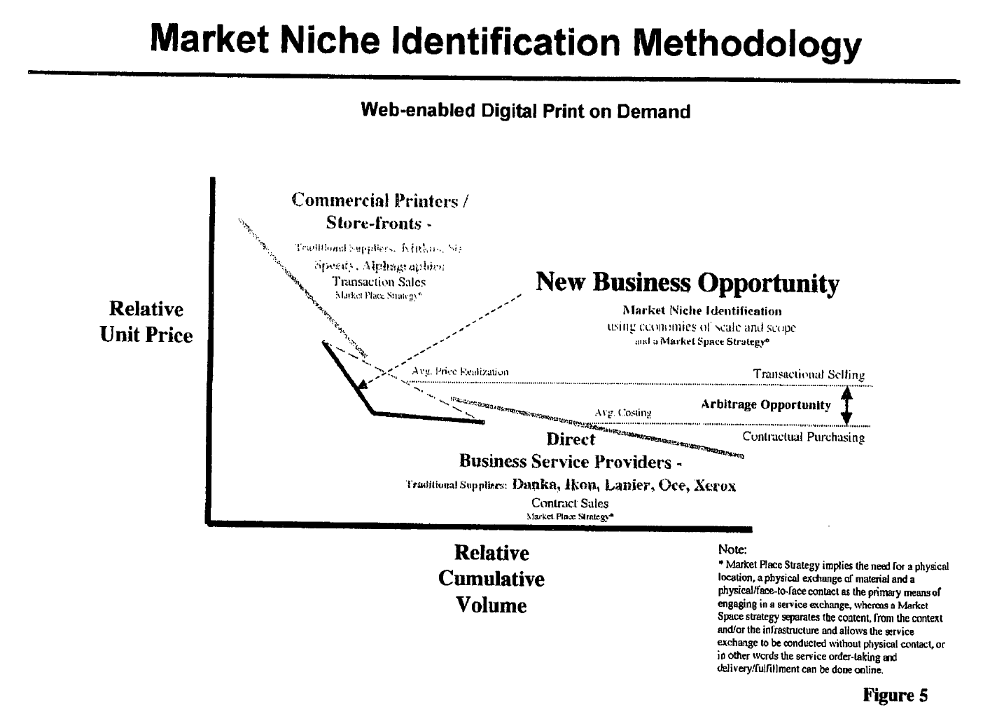

FIG. 5 is a market niche identification methodology that is utilized in finding new business opportunities within the knowledge services domain in the commercial office building market segment. It is clear that most existing players utilize a market-place strategy, which focuses only on physical aspects, such as a physical store-front location and a physical exchange of goods and services, whereas the method of the invention utilizes a market-space strategy to play in a segment that is not catered to by traditional suppliers either because (a) their business model is a retail model with high unit pricing, or (b) their business model is a dedicated service fulfillment for very large customers who singly can offer the economies of scale needed for the right pricing. The market-space strategy of the present invention separates content from context and infrastructure so a web-portal can be used as an interface for the tenant occupant to link them to the individual service providers via the venue onsite. There is a market niche where users when combined together can offer service providers economies of scale matching and exceeding that of very large users and where such users are willing to pay competitive commercial/storefront transaction pricing. This gives rise to an “arbitrage opportunity”, if you will, for this particular market segment if they can be organized according the business method of the invention.

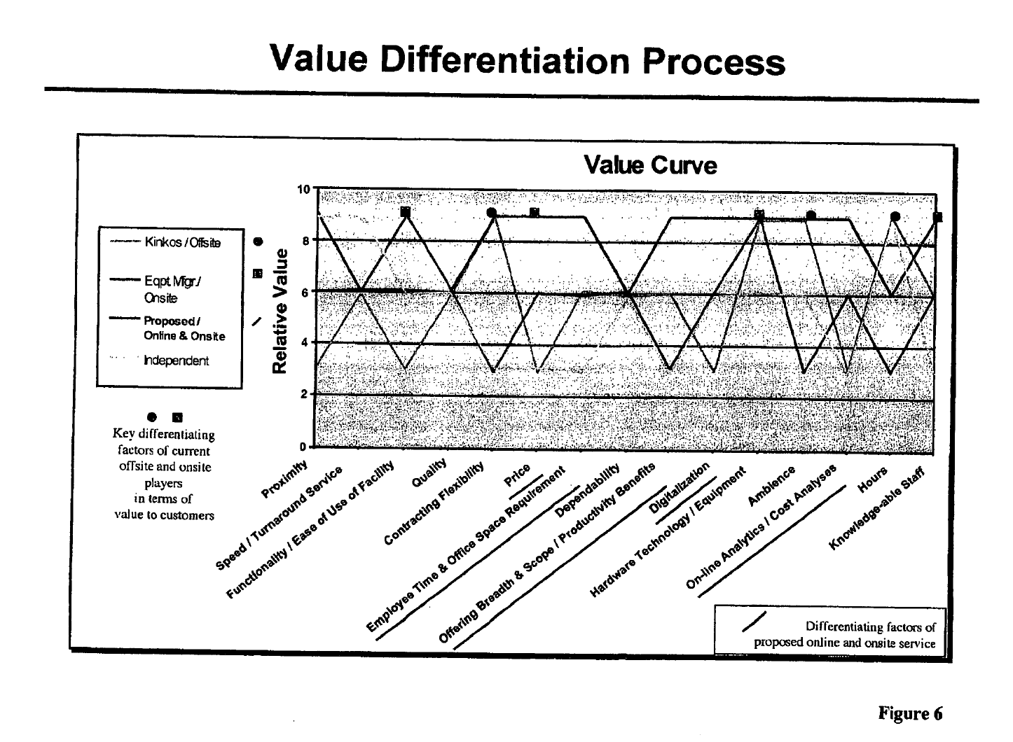

FIG. 6 shows the value differentiation process adopted according to the invention to differentiate the relative value of various factors important to tenant occupants/end users of knowledge/business services. The factors have been mapped out to compare the method of the invention to traditional methods. The particular factors relating to digitalization, online analytics and offering breadth and scope with productivity benefits accruing to end users, are major sources of advantage according to the business method of the present invention.

According to the method of the invention, tenant occupants and end users, who become the ultimate beneficiaries of the economies of scale and scope that they generate and, therefore, get virtually locked into the system with the value proposition of (a) high quality, (b) low price, and (c) best in class individual service providers backing fulfillment, enjoy benefits including:
1. Trust due to existing relationship with landlord, participator with the provider of service according to the invention
2. Convenience—on-line and on-site; reliability and quick turnaround
3. Unified periodic billing and cost management, as opposed to multiple-transaction billing, with automated tracking as opposed to internal tracking at own higher costs
4. High quality and loyalty-based low pricing, based on ultimate outsourcing to high quality individual service providers/suppliers
5. Technology at doorstep with maintenance, training and safety-stock efficiencies
6. Ease of acquisition and confidentiality relative to current multiple-supplier model
7. One-stop shopping for all business services, based on needs, with a combination of e-commerce and human interface

The building owners, on the other hand, also observe new benefits including:
1. Improved value proposition for main business—greater than opportunity cost of space
2. Virtually captive business in growing market
3. Specialized knowledge-base, trained on-site staff, technical and marketing support
4. Ability to provide convenience and deliver on-going productivity to tenant customers, and thereby gain longer term tenants or tenants willing to pay a premium for the space relative to other office building space offered by competitors
5. New revenue opportunity with relatively little effort or investment
6. Opportunity to increase income and expand portfolio
7. Long-term partnership arrangement with no risk

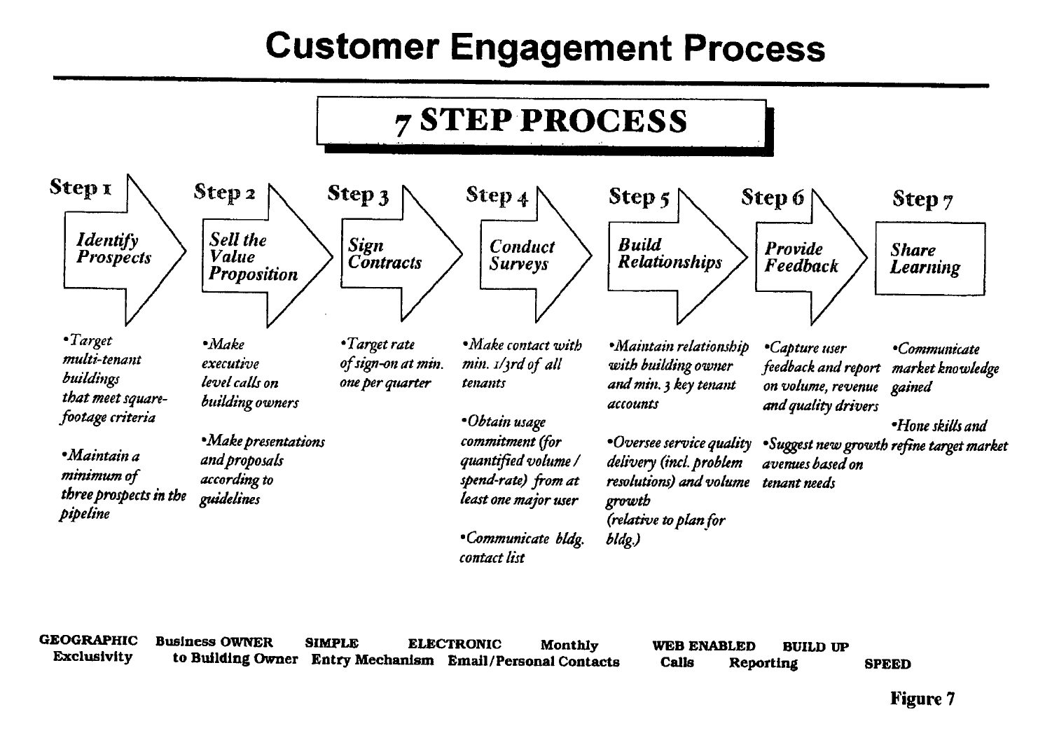

Agents, according to the method of the invention, preferably follow a seven-step customer engagement process, as depicted in FIG. 7 and as described below:
1. Identifying building owner prospects and maintaining a minimum number of active prospects;
2. Selling the value proposition to the building owners by making executive level calls and formally making presentations;
3. Signing contracts with building owners at a given target rate per fixed time period;
4. Conducting surveys within the buildings by contacting a minimum tenant company population and attempting to obtain commitments for usage;
5. Building relationships with the building owner and with key accounts/potential users within the building(s) and overseeing the quality service delivery;
6. Capturing user feedback, reporting on volume, revenue and quality drivers, and suggesting new growth opportunities for the building(s) in question; and
7. Sharing the learning by communicating the market knowledge gained with the principal and other eligible agents, and honing skills to refine the target market based on new learning.

Agents aid in the market creation in the market niche identified according to the invention with a geographical focus. The above processes allow for rapid evolution of the concept and speed in terms of taking just-in-time inventory management to a whole new level with multiple service fulfillment to multiple users.

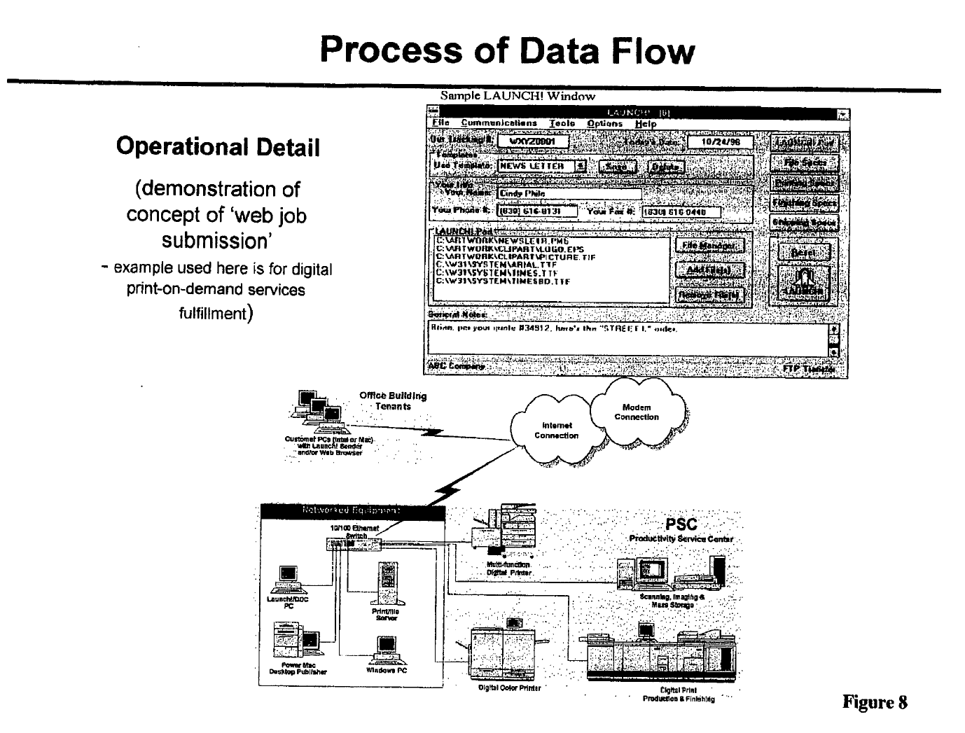

Exemplary operational details have been shown in FIG. 8 demonstrating linkages and connectivity for print on demand service fulfillment from service center by an initiation from a tenant user desktop. An example of the networking within a service center according to the method of the invention has also been shown.

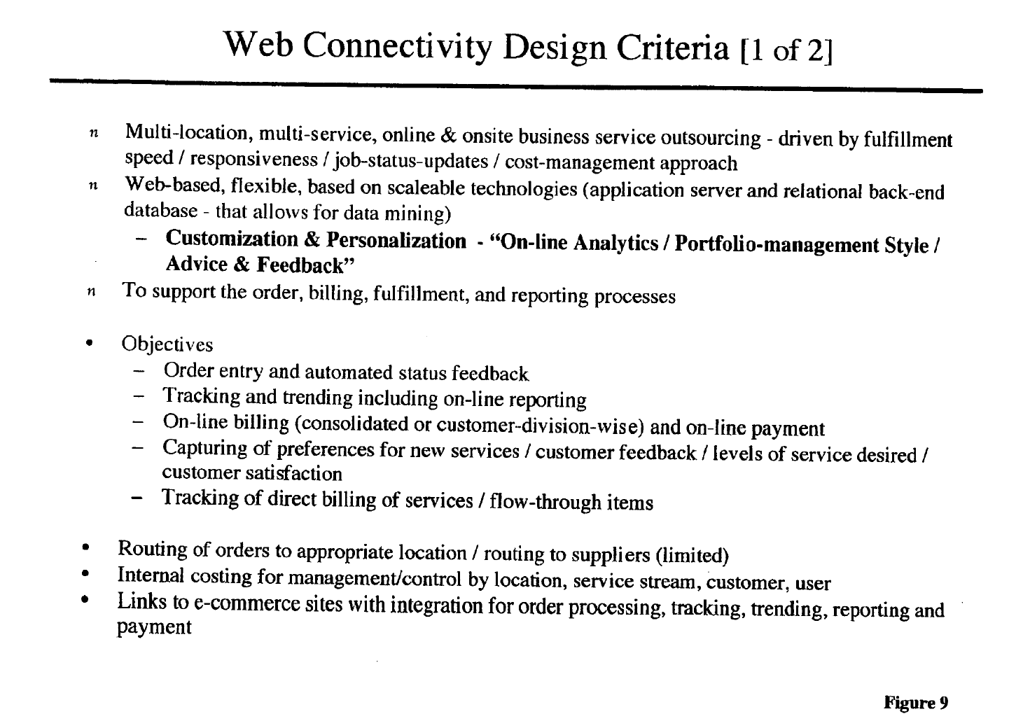

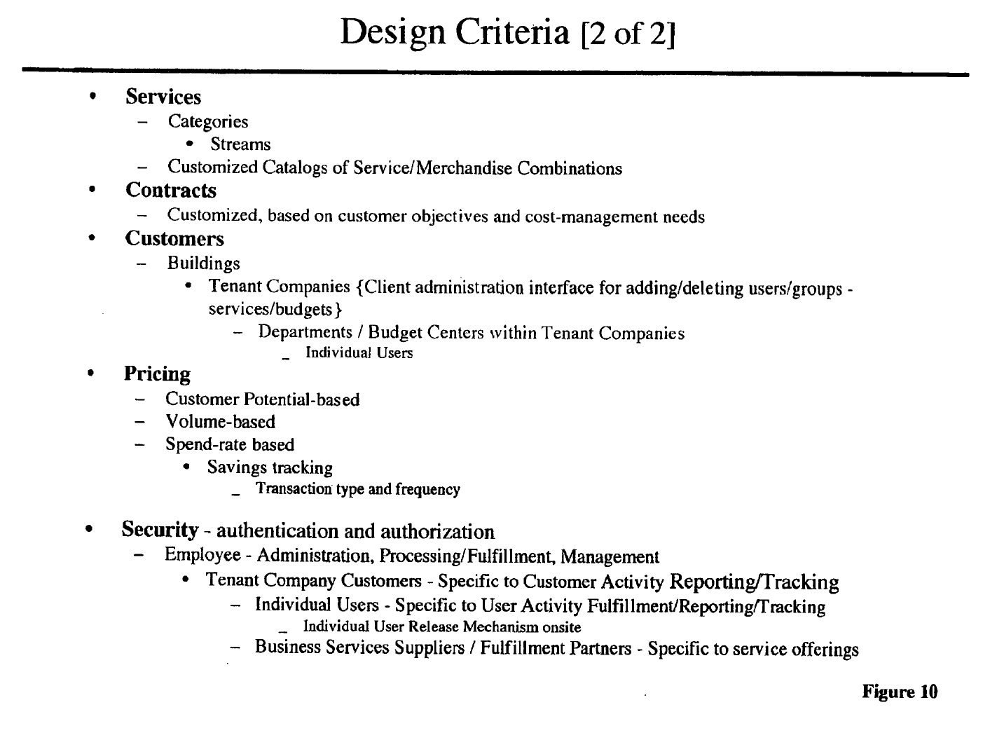

There are certain design criteria that need to be followed according to the business method of the invention to create a web-based system that allows for efficient pooling, processing and fulfillment. This has been outlined in FIG. 9 and FIG. 10. The whole design criteria is based on a multi-location, multi-service, online and onsite business service outsourcing model that is web-based, flexible, scaleable, utilizes application server and relational database technology, and supports the order-taking, billing, fulfillment, reporting and tracking and trending processes, including routing of orders to appropriate locations/buildings/fulfillment centers of partners/others.

The system is one that is capable of handling multiple service streams, mass-customized contracts, custom and real-time pricing based on multiple criteria such as customer potential, spend-rates, volumes and overall usage and security for authentication and authorization.

My invention also includes a service delivery and dynamic balancing system that allows users to select the print function from the file menus of the browser or application they are working in to directly compress, encrypt, add meta-information to, and send files seamlessly to the web-based processing system of the invention. Traditional methods of sending files securely over the web include encrypting and sending via e-mail or file transfer done in several sequential steps. The service delivery system of the invention would automate this step without the need to close the application of file in use, and achieve the same results with less effort and at a faster speed. And, a dialogue box would accept meta-information pertaining to the file such as desired delivery time, mode of delivery, etc. At the receiving end, the file would be received instantaneously, get routed to the server capable of scheduling the service request, send an instant message via a dialogue box back to the user confirming receipt of the service request and advising the status of the job while being processed.

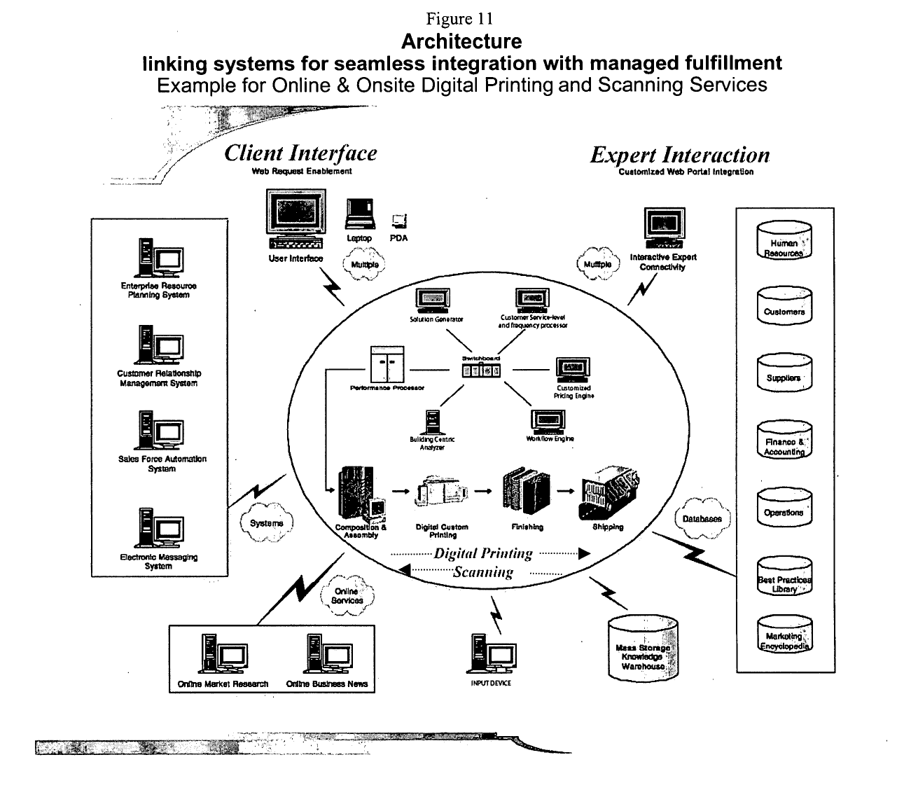

As particularly seen in FIG. 11, which is a schematic multidimensional chart illustrating the relationships between the different data flow components according to the business method of the invention, the implementation of the invention includes the steps of:
a. Setting up a database of tenant companies and occupants within a multi-tenant commercial office building
b. Plugging in the square footage occupied by each tenant company within the building
c. Plugging in data related to service level requests by occupants
d. Using data from external published sources to plug into the database an estimate of the volume of outsourcing currently being experienced for business services
e. Using a protocol to compute anticipated volumes of outsourced digital printing by occupant and by square footage within the building and to identify potential end users
f. Using a workflow processing system that connects several digital printing machinery to computers within a physical space inside the multi-tenant building
g. Linking the database and the protocol to the workflow processing system to connect end users with their specific service requests directly to the service center within the building space to link to the digital printing machinery and computers
h. Using a protocol to relate information from end users with the database pertaining to fulfillment of the service requests such as finishing options, quantity, time-frames, delivery addresses, etc.
i. Alerting assigned persons responsible for service fulfillment at the service center via email and a wireless device so they are instantly notified of a service request with all relevant metainformation
j. Integrating the usage information and feeding the information back to the database and processing system

An example of how digital printing and scanning services are fulfilled according to the business method and processing system is shown in FIG. 11. The processing system as shown comprises the following:
(i) an input device that selectively requests and allows input of data relating to outsourced volumes for digital printing and scanning services;
(ii) an expert interaction interface that allows for uploading of files and for specific meta information relating to how the files be processed at the specific digital printing and scanning equipment interconnected to the processing system;
(iii) a client interface that enables submission of service requests;
(iv) a switchboard that imports data from at least one database relating to one or more of input device, expert interaction system, client interface, financial information, human resources information, customer information, supplier information, and or specialized expert information via databases into the processing system;
(v) a building centric analyzer that receives the data and processes, renews and updates relevant information pertaining to space occupancy and user service fulfillment requests preferences such as finishing options, typical quantities, quality and type of service output desired, typical time-frames for turnaround, and delivery addresses for service fulfillment requests;
(vi) a performance processor that assimilates the building centric analyzer information and the data imported by the switchboard to process linkages between the data, form clusters of elemental information, and make appropriate computations, associations, and new linkages;
(vii) a customer service level and frequency processor that can use a protocol to receive customer and other relevant information including information and meta information about customer needs, requirements and desired states from the switchboard, update and process the information dynamically and compute and assigning attributes to any service request as and when received in real time;
(viii) a customized pricing engine that keeps track of pricing points for different service elements for different clients and automatically computes the relevant service ticket and invoicing information based on specific service requests, providing feedback to the performance processor; and
(ix) a solution generator that receives data from the building centric analyzer, the switchboard, the performance processor, the customer service level and frequency processor, and the customized pricing engine, and generates solutions based on these data, and delivers solutions for output to the interconnected composition and assembly machinery and the digital printing and scanning equipment for appropriate service fulfillment.

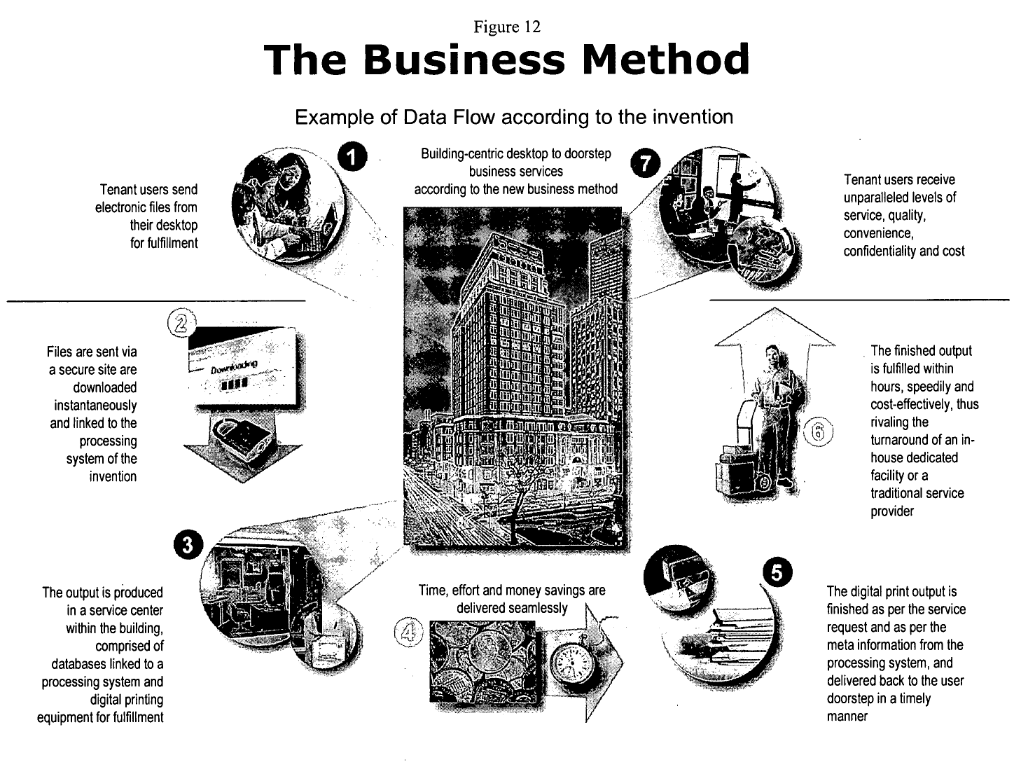

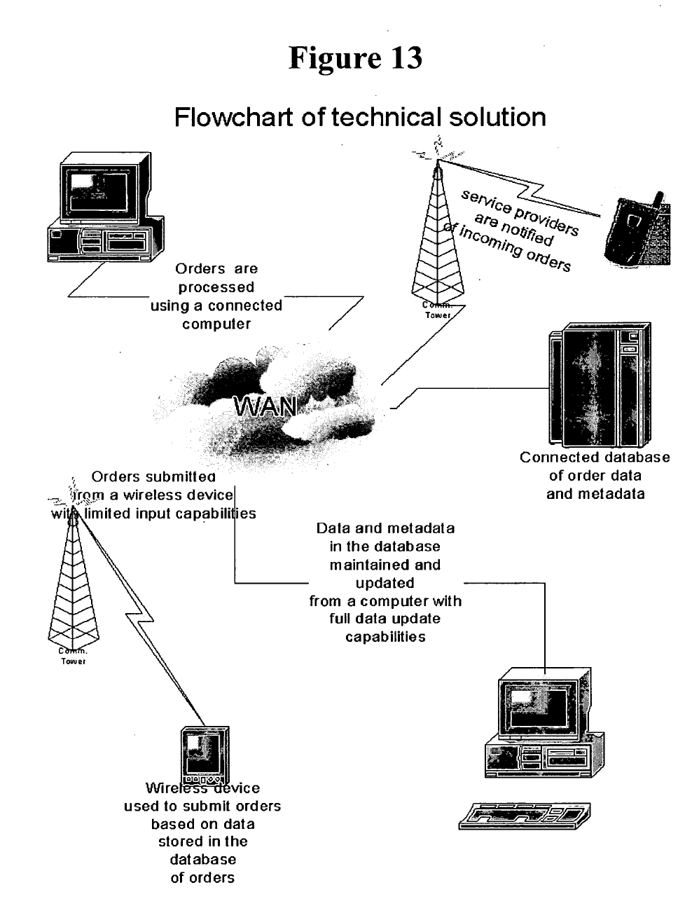

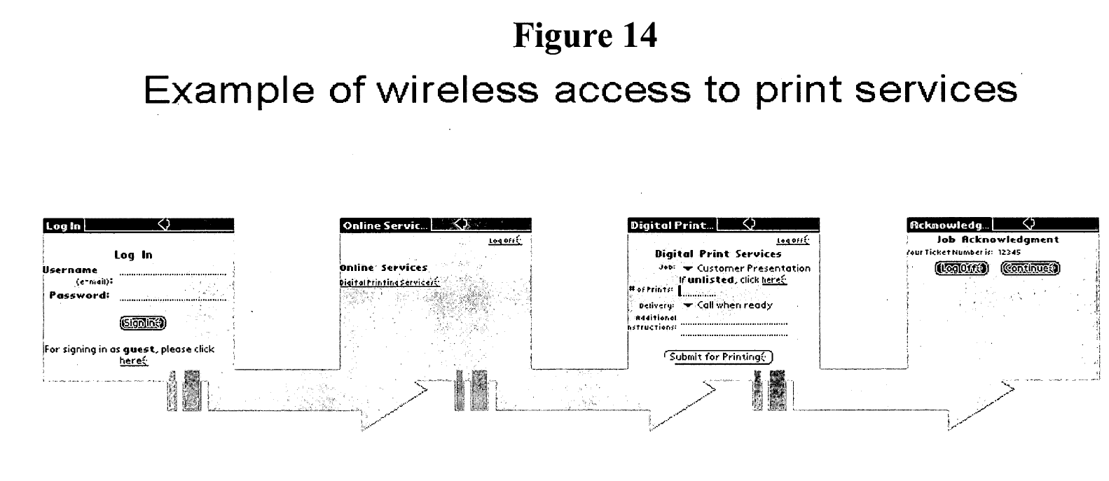

As particularly seen in FIG. 12, which is a schematic diagram illustrating a preferred process of data flow according to a method of the invention. The particular example depicted is for digital printing services fulfilled for users within a large building and comprises the steps of:
a. Tenant users send electronic files from their desktop for fulfillment to the service center;

B. Detailed Description of Wireless Delivery Methodology and System

The invention is a technical solution that allows users to create and maintain a library of orders through the web that can be consequently accessed and re-ordered from a range of wireless devices. The solution allows users to also track the status and pay for their orders using the wireless device in addition to placing orders.

The system of the current invention accomplishes the following:
1. Set up a web accessible database that allows users to create and maintain online a library of jobs (each of which can contain data as well as metadata about the order). This is enabled by providing user accounts protected by authentication and authorization (including, but not limited to username and password) mechanism.
2. Providing screens that will allow a user to create new, edit, update and delete existing orders. These orders can be for a wide range of services including, but not limited to, digital printing, courier service, equipment rental, as well as product and service procurement.
3. Providing a way to share these orders within a defined group of users (such as company or department). Therefore in addition to creating and maintaining a personal library of orders, a user can add his/her orders to the library of orders accessible to the above-mentioned group. This way a user can leverage not only his/her own resources but also the resources that were created and made available by others, significantly increasing the productivity and usefulness of this solution.
4. Making the database accessible through a wide range of wireless devices. The user will again be required to provide his/her credentials to log into his/her account. After doing that he/she will get access to all previously created orders (both personal as well as those that are shared by the group where this user belongs) as well as track previously submitted orders (submitted from both the web as well as a wireless device) and pay for completed orders.

C. Detailed Description of Choiceboard Methodology and System

The invention is a business method that helps to create a Choiceboard, which is nothing other than an e-service exchange amongst tenant companies occupying buildings of a common building owner or REIT.

The business method of the invention accomplishes the following:
5. Establish an electronic mechanism for connecting tenants of large commercial office buildings for the purposes of transacting business. This will consist of a mechanism to seek out other tenants in any of the buildings connected to this network, review any offers that they have available for other participants, request information, send proposals to them using the system, receive, respond and process inquiries and proposals from others, close the transaction and remit and collect payment through the system.
6. Provide for below-market pricing for participants in this business network. This will be achieved by the participants offering preferred pricing to other members of the network.
7. Deliver efficiencies by streamlining the search, engagement, negotiation and settlement stages of a business transaction. This will practically eliminate the cost of acquiring new business for the members of the Choiceboard, which will in turn allow them to offer above-mentioned below-market pricing without sacrificing their profit margins.
8. Use an existing network of building centric portals, each of them with existing membership of employees from tenant companies to build a sizeable enough network to be able to be able to build up a wide range of product and service offerings
9. Use an existing relationship that tenant companies have with the provider of this Choiceboard through the use of the above mentioned building portals.

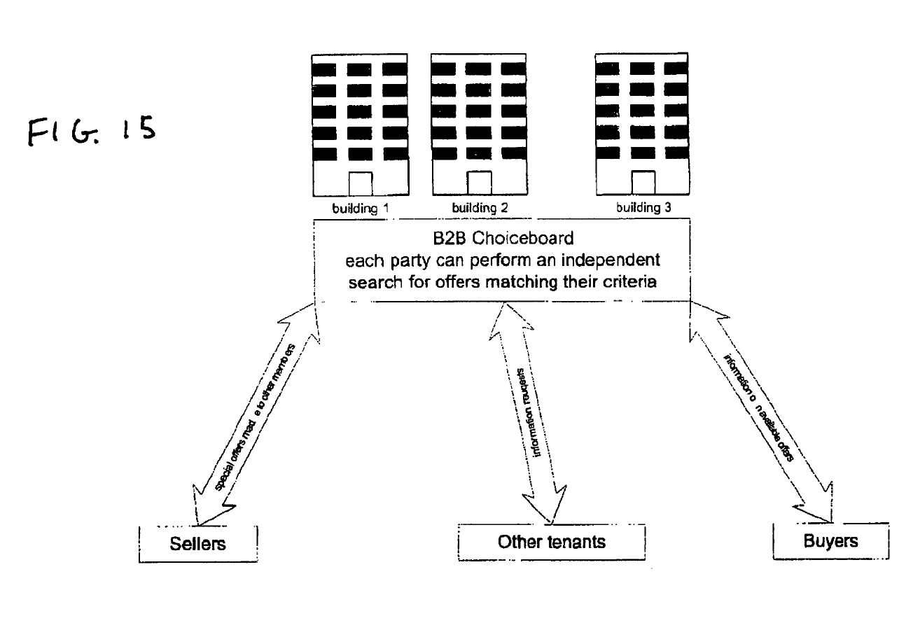

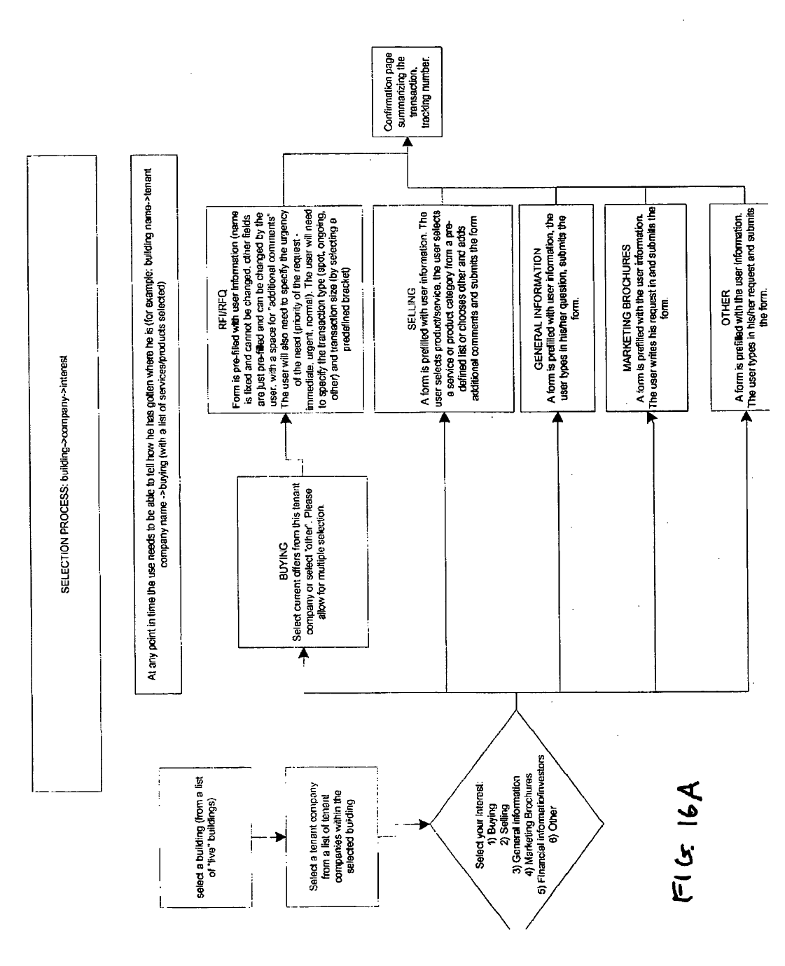

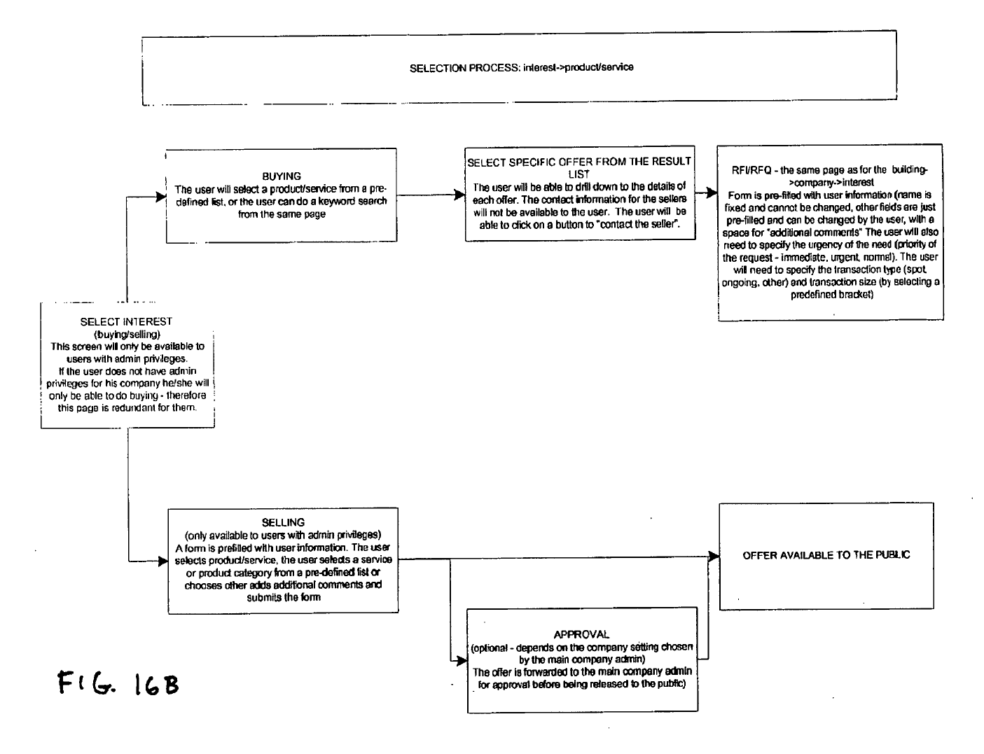

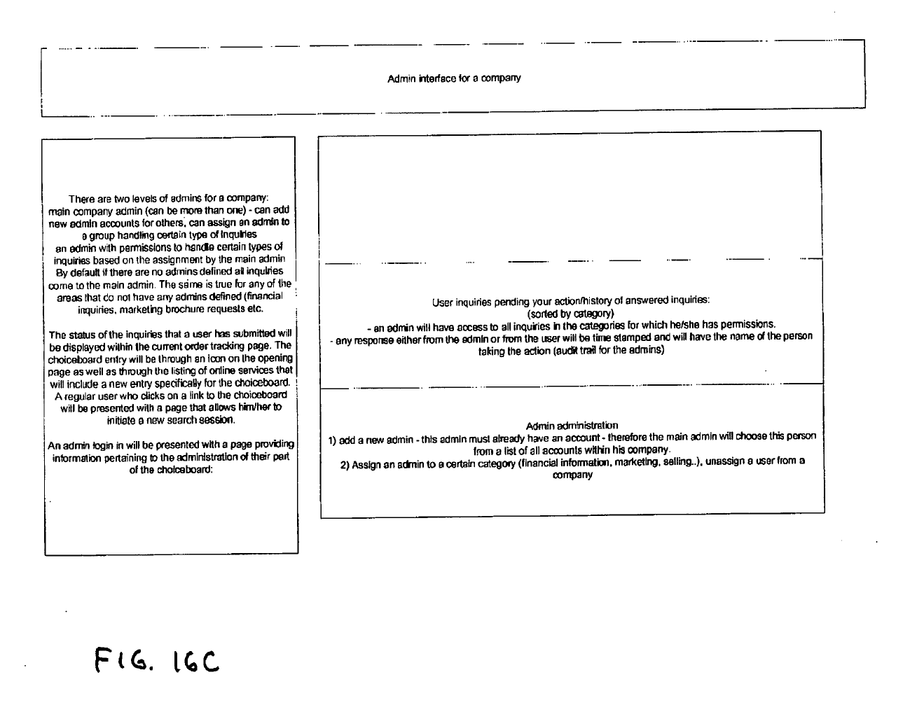

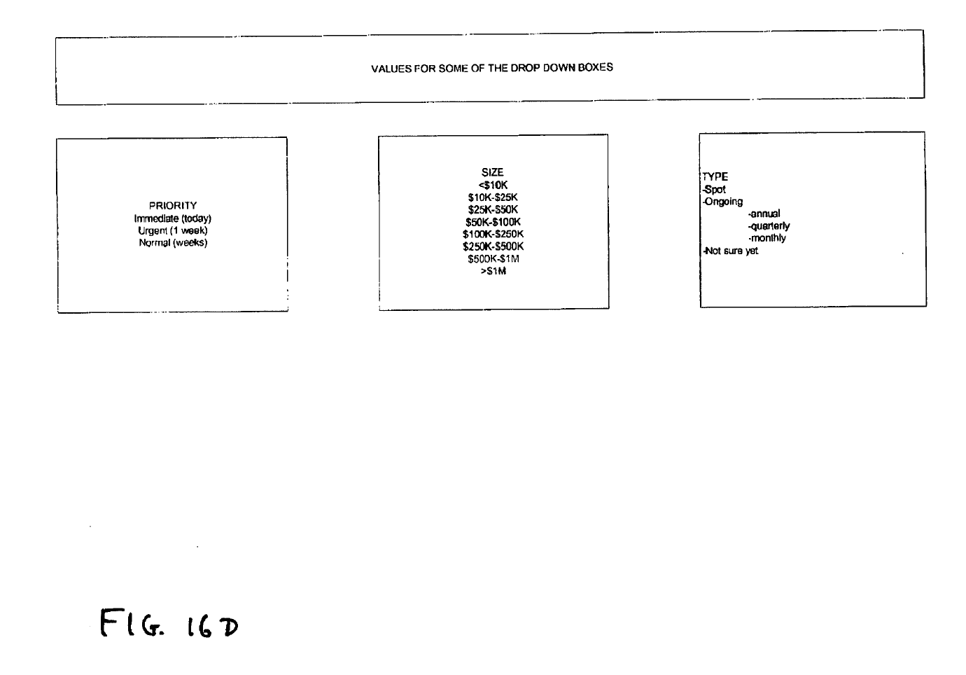

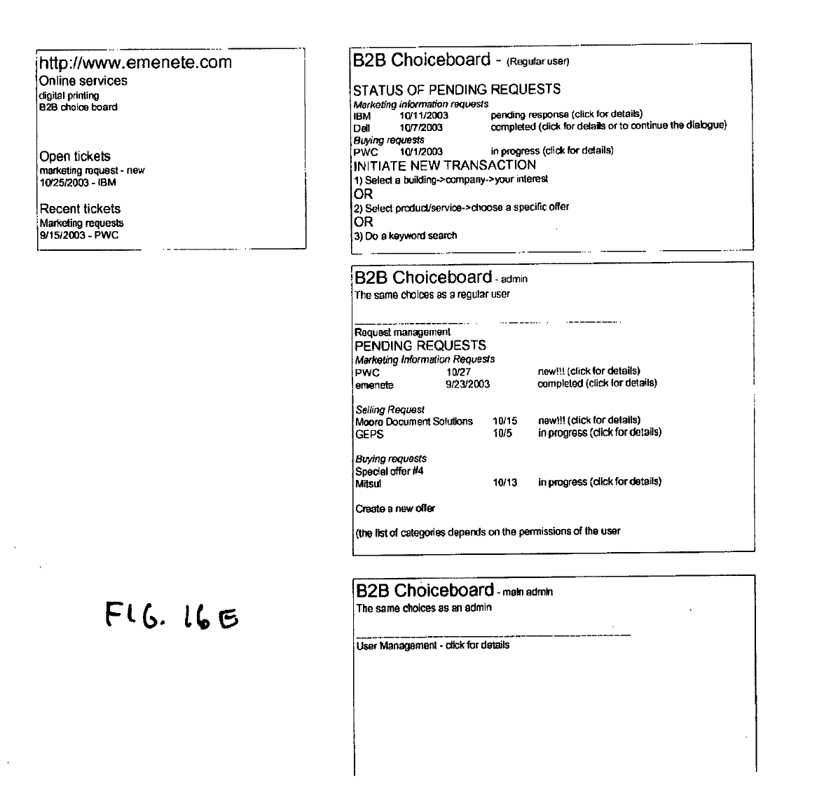

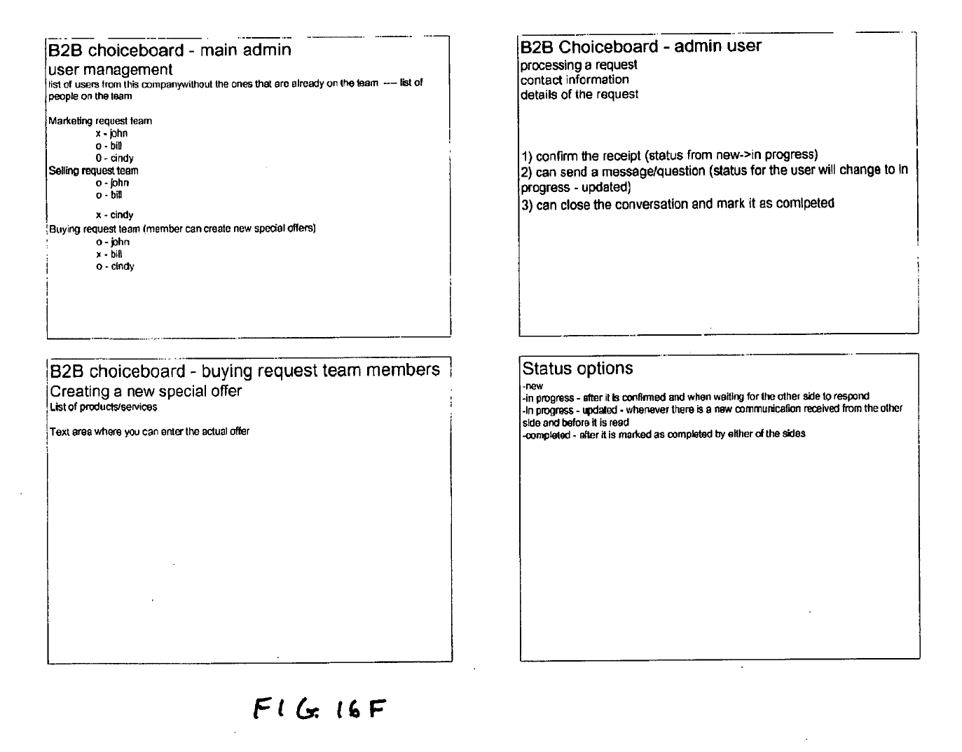

FIG. 15 is a diagram of the business methodology as it links individual tenants through the use of the Choiceboard acting as a central matchmaking and clearing facility. All requests are stored in the Choiceboard and available for search by others. Both buyers and sellers can connect to the Choiceboard either simultaneously or at their own leisure to scan the database, add to it, and transact business. The uniqueness of this approach is the fact that the Choiceboard connects tenants of commercial office building—vs. general public. As seen in FIGS. 16A through 16F a user can perform a search based on building->company->offer, interest->offer, or keyword.

### D. CONCLUSION

From the foregoing it will be clear that my invention includes at least the following:

1. A business method for use in at least one property housing a large number of separate departments with appropriate populations and infrastructure that would justify the setting-up of a connected strategic outsourcing venue for knowledge/business services, that comprises:
(a) obtaining a physical venue for the setting-up of a strategic outsourcing of knowledge/business services center for pooling the requirements of users and for efficient fulfillment, processing and service delivery;
(b) using at least one of existing web-based connectivity and a newly designed network in the property so that tenant occupants/users within the building/property are able to submit orders to the service center online and so that the order logging, processing, routing and fulfillment may be done by at least one of online, onsite, and offsite and delivered to the user efficiently incurring the lowest possible distribution costs;
(c) partnering with individual service providers to fulfill the specific service offerings in a cost-effective manner by bringing economies of scale to them by pooling the requirements of all tenant occupants/users from multiple buildings so that experts from each service stream can be engaged to take ultimate responsibility for the service delivery to the end users, including at least one of installation of equipment, maintenance, supplies, training and key operators where applicable;
(d) providing multiple-services through flexible service combinations from the service center and offering a breadth and scope that is dynamic and based on user requirements surveyed periodically and as captured over time;
(e) providing cost-management to users of the multiple services in a portfolio-style management with manual and/or online tracking and trending of usage; and
(f) providing online billing, payment and transaction processing capability for multiple users, multiple services and multiple individual service providers, simultaneously, in real time and efficiently.

2. A web-based processing system wherein a tenant occupant/end user is interconnected from a property via a computer network to a system that performs a method including the steps of:
(a) supporting at least one of order-entry, coordination, processing, fulfillment, billing, payment and reporting processes;
(b) providing order-entry confirmation for knowledge/business services immediately upon receipt and giving automated status feedback at predetermined intervals;
(c) providing customized service catalogs with customized and personalized pricing and selectively providing custom contracts based on pre-determined inputs;
(d) providing usage tracking and trending, including online reporting to users;
(e) providing online billing consolidated by at least one of a customer and the service provider, and providing capability to process online payments;
(f) routing orders automatically to one of an appropriate service center, fulfillment site, and server of an individual original service provider for ultimate processing and/or fulfillment;
(g) tracking flow-through items with details of recency, frequency, usage and monetary value;
(h) providing portfolio style cost-management online; and
(i) capturing preferences of users for new services as well as captures customer feedback on desired service levels and on-going customer satisfaction

3. A web-based processing system wherein a tenant occupant/end user is interconnected from a property via a computer network to a system that performs a method including the steps of:
automatically accepting, scheduling and routing service requests to the appropriate fulfillment center based on desired service level, type of service, capacity utilization, load factors at various centers, and other such factors; and
immediately confirming receipt of the request to the requester with information pertaining to when and where the request will be fulfilled and confirming completion of the service request when done via an instant messaging system or a dialogue box that can be opened with at the click of a mouse containing meta-information, or via normal e-mail, where such communication is processed automatically by a processing system and communicated in real-time to the requester or user.
4. A web-based processing system wherein a tenant occupant/end user is interconnected from a property via a computer network to a system that performs a method including the steps of:
automatically accepting, scheduling and routing service requests to the appropriate fulfillment center based on desired service level, type of service, capacity utilization, load factors at various centers, and other such factors; and
immediately confirming receipt of the request to the requester with information pertaining to when and where the request will be fulfilled and confirming completion of the service request when done via an instant messaging system or a dialogue box that can be opened with at the click of a mouse containing meta-information, or via normal e-mail, where such communication is processed automatically by a processing system and communicated in real-time to the requester or user, the system further including the steps of:
supporting the order-entry, coordination, processing, fulfillment, billing, payment and reporting processes;
providing order-entry confirmation for knowledge/business services immediately upon receipt and gives automated status feedback at predetermined intervals;
providing customized service catalogs with customized and personalized pricing and custom contracts, if needed, based on pre-determined inputs;
providing usage tracking and trending, including online reporting to users;
providing online billing, both consolidated and/or by customer/division/user—and has the capability to process online payments;
routing orders automatically to the appropriate service center or fulfillment site or server of an individual original service provider for ultimate processing and/or fulfillment;
tracking flow-through items with details of recency, frequency, usage and monetary value;
providing portfolio style cost-management online; and
capturing preferences of users for new services as well as captures customer feedback on desired service levels and on-going customer satisfaction,
the combination of which allows individual desktop and other users to select one of the print and some other function from the file menus of their applications/web-browsers to automatically carry out a method including the steps of:
directly compressing, encrypting, adding meta-information such as service request details and other processing and pertinent information according to a template via a dialogue box, and sending the respective open file/s seamlessly to the web-based processing system of the invention, at the click of the mouse/appropriate button;
immediately receiving a receipt or response back via a dialogue box, generated automatically from the web-based processing system of claim 3, confirming receipt of the file and the service request;
to receiving a confirmation that the fulfillment will or will not be done according to the desired time-line as entered in the meta-information with the service delivery request and a communication of the expected delivery time and date, based on a scheduling algorithm in the processing system; and
receiving confirmation when the service request is fulfilled and ready for delivery or pick-up as the case may be via a dialogue box.

5. The business method of paragraph 1, above, wherein the venue includes adequate floor space.

6. The business method of paragraph 1, above, wherein the step of selling the value proposition of knowledge/business services in a pooled manner to an entity in charge of the least one property includes negotiating terms that allow a flexible engagement within the at least one property.

7. The business method of paragraph 1, above, wherein the entity is paid for use of the venue on the basis of a share of at least one of revenues and profits generated from providing such knowledge/business services to the tenant occupants/users within the property.

8. A system that comprises:
A database of service transaction orders that can be created and maintained by a registered user through the Internet. Access to such a database is protected by an authentication and authorization mechanism to prevent unauthorized use. An order comprises of all data and metadata necessary to provide a business service such as digital printing, scanning and shipping to the user with details such as quantity, type of service, associated files, finishing options, delivery location and other parameters of the service request.
A processing system that allows several users to belong to one user group and to share orders created by one of the users in a shared library of orders. The definition of an order remains the same with the difference being that these orders can be accessed and re-used by any of the users from within the group.
A processing system that allows users to access the above-mentioned library of orders from a wide range of wireless devices, and re-order the business service in question by selecting a particular job from the library and submitting the data and metadata.
A closed-loop system that allows users to track and pay for any of their service requests via the web, including jobs submitted from a wireless device.

9. A system that alerts the service provider of the business service such as digital printing, scanning, shipping or other through the wireless system of claim 1 whenever a new order is submitted as well as about other events that need their attention, such as escalation of an order that has not been attended to or updated for a certain amount of time.

10. The system of paragraph 8, above, specifically used for wireless ordering of digital printing services where
A user can create a print job order by uploading file(s) to be printed and entering metadata associated with the order and uploading both to a server.
The metadata are later used to re-order the printing of the uploaded file(s) through a wireless device.
As an alternative, print job related metadata could be added to a previously uploaded file(s), either through the web or through a wireless device. This enables the printing of previously stored files (not originally intended to be printed) remotely without the necessity to re-upload them to another system.

11. The system of the present invention where the wireless ordering of business services is based on a previously created library of orders. Wireless devices have inherently poor input and transmission capabilities—therefore making the ordering of services inefficient and time consuming. This particular invention makes it possible to remain productive by retrieving order data and metadata from an online library (created and maintained through devices better suited for that task—such as web connected PCs), adding data specific to the current order (quantity etc) and submitting it from a wireless device. Furthermore it makes is possible to track and pay for the orders previously submitted by the user by using a wireless device. The invention also makes it possible to share items from such a library between a defined group of users.

12. A system that closes the cycle of use of wireless devices for business services online delivery, by linking users of business services to the fulfillment providers through wireless devices that alert the fulfillment providers to new order submissions as well as to any other events that need their attention (such as an order that has not been updated for a certain period of time and will therefore be escalated to their attention)

13. The methodology of ordering business services via wireless devices comprising the steps of:
(a) A user logging into the processing system of claim 8
(b) The user requesting a particular service from a drop down box
(c) The user referring to a file from a library as appears on the screen of the wireless device
(d) The user confirming the service request and updating the request with all pertinent information such as desired delivery location, time and date among other details
(e) Where the user receives notification of the status of the service requests after submitting such requests
(f) Where the user can pay for the services upon completion.

14. A processing system that comprises a web-based portal and transaction processing system wherein the tenant occupant/end user is interconnected from within a commercial office building/university/government property via the web to a number of other tenant occupants, whether or not owned by the same building owner, wherein the system enables transaction processing and business/commerce between neighbors in accordance with the following steps of:
supporting a search process by location/building, industry, keyword, and product/service offering interest to find a list of preferred offerings made available to the community of tenant occupants or making preferred offerings available to the tenant community;
providing a requisition management system for making requests to procure specific products/services by announcing the same to the community of tenant occupants; the user making the request will have the choice to include and exclude any other members of the community from the list of recipients, therefore allowing the user to create offers ranging from being specific to one tenant to offers being made to the entire community;
providing an offering creation system so as to allow tenant occupants to make specific product/service offerings available to other tenant occupants at pre-determined pricing that need not be negotiated and on terms favorable to the community based on predetermined criteria/inputs; again the user creating the offer can exclude other members from seeing this offer. That way the information can be protected from being accessible to competing companies;
Performing a matchmaking of business needs;
providing tracking, time and date stamping, categorization and other features for listing of product/service offerings either for requisitioning for procurement or for marketing to others;
providing online transaction processing enabling the financial and contracting transaction including online billing and online payment to take place between tenant occupants for such preferred offerings.
15. The processing system of paragraph 14, above, wherein:
(a) the routing of orders is done automatically via the building owner's database for transaction tracking;
(b) revenue share adjustments and computations are done as customized and deemed appropriate by the respective building owners;
(c) tracking of flow-through items is done with details of recency, frequency, usage and monetary value;
(d) a portfolio style cost-management system is made available online for the preferred offerings and with possibility to make comparisons to publicly available market pricing.

16. The processing system of paragraph 14, above, wherein the following features are enabled:
(e) capturing of preferences of users for new services as well as feedback on offerings most frequently made available to the community of tenant occupants for improved transaction processing efficiency and for opening up the marketspace;
(f) Providing online processing of the requests received in a three step process—confirmation, clarification of the request (questions and answers are both logged in a database to provide a complete history of the processing of each request). Each step is time stamped, and the name of the user who performed the step is associated with the step, ensuring accountability and audit trail information.
(g) Providing user profiling, authorization and authentication. User information is entered once and is retrieved from the database for all subsequent uses. During all subsequent visits the user only needs to log in and all personal information is filled out by the system.
(h) Providing user management functions to designated company administrators that will allow them to appoint users from their companies to fulfill various functions within the system. This means administration of user rights as they apply specifically to the Choiceboard system. An administrator can assign a user to a group the manages buying requests, selling requests, or any other type of requests that are defined in the system. In addition to immediate search of the currently outstanding offers, a user will be able to set up automatic agents that will continuously scan the available offers and prompt the owner when an offer matching his/her criteria becomes available in the system.

17. Providing the functionality of paragraphs 14, 15 and 16, above, through a range of wireless devices in addition to the claimed web interface. This will allow the users of this system to perform any of the function through the use of a wireless device.

18. A business method of linking neighbors in multi-tenant commercial office buildings for exchange of business transactions between themselves using the processing system of paragraphs 14, 15 and 16, above.

However, many variations are possible without exceeding the ambit of the inventive concept. Accordingly, it is to be understood that the embodiments of the invention herein described are merely illustrative of the application of the principles of the invention. Reference herein to details of the illustrated embodiments is not intended to limit the scope of the claims, as they currently exist or may be hereafter amended.

1. A web-based processing system wherein a tenant occupant/end user is interconnected from a property via a computer network to a system that performs a method including the steps of:
automatically accepting, scheduling and routing service requests to the appropriate fulfillment center based on desired service level, type of service, capacity utilization, load factors at various centers, and other such factors;
immediately confirming receipt of the request to the requester with information pertaining to when and where the request will be fulfilled and confirming completion of the service request when done via an instant messaging system or a dialogue box that can be opened with at the click of a mouse containing meta-information, or via normal e-mail, where such communication is processed automatically by a processing system and communicated in real-time to the requester or user; and
maintaining a database of such service requests and their fulfillment.

2. A web based processing system as described in claim 1, wherein access to said database is protected by an authentication and authorization mechanism to prevent unauthorized use.

3. A web based processing system as described in claim 1, wherein a service request comprises all data and metadata necessary to provide a business service such as digital printing, scanning and shipping to the user with details such as quantity, type of service, associated files, finishing options, delivery location and other parameters of the service request.

4. A web based processing system as described in claim 1, wherein said system allows several users to belong to one user group and to share orders created by one of the users in a shared library of orders.

5. A web based processing system as described in claim 4, wherein users can access said library of orders from a wide range of wireless devices, and re-order the business service by selecting a particular job from the library and submitting the data and metadata.

6. A web based processing system as described in claim 1, wherein the system enables transactions between users by supporting a search process by at least one of location, building, industry, keyword, product and service.

7. A web based processing system as described in claim 1, wherein said system provides a requisition management system for making requests to procure specific products and services by announcing same to the system users.

8. A web based processing system as described in claim 7, wherein a user can choose to include and exclude other users from the list of recipients, thereby allowing the user to create offers ranging from being specific to one tenant to offers being made to all users.
